(19) United States
(12) Patent Application Publication
(10) Pub. No.: US 2024/0070031 A1
(43) Pub. Date: Feb. 29, 2024

(54) METHOD AND SYSTEM FOR DATA RECOVERY BY A HARDWARE-INDEPENDENT APPROACH INVOLVING PRIORITIZATION AND DATA RECOVERY SELECTIVITY

(71) Applicant: SAUDI ARABIAN OIL COMPANY, Dhahran (SA)

(72) Inventor: Abdullah Saleh ALSAEED, Dhahran (SA)

(73) Assignee: SAUDI ARABIAN OIL COMPANY, Dhahran (SA)

(21) Appl. No.: 17/822,327

(22) Filed: Aug. 25, 2022

(51) Int. Cl. G06F 11/14; G06F 16/11

(52) U.S. Cl. CPC G06F 11/1451; G06F 11/1469; G06F 16/116; G06F 2201/84

(57) ABSTRACT

A system and method for backup and restoration include converting files stored in a main storage device to flat files for storage in a backup storage device, storing the flat files in a backup device, and restoring the flat files from the backup device based on a restoration priority order that is independent of an order in which they were stored in the backup device.

### FIELD OF THE DISCLOSURE

The present disclosure relates generally to computer data preservation and, more particularly, to backup and restoration of computer data.

### BACKGROUND OF THE DISCLOSURE

Conventionally, computer data backup and restoration are performed without regard to the nature of the data or its criticality. Often the approach is to back up and restore all the data in bulk, and without regard to the differences in criticality of different files. Such an approach can be very time consuming and data restoration can impose significant system time. In addition, backup schemas are traditionally system- and platform-specific, with different components imposing different constraints on the data being backed up and the methods utilized for conducting the backups and restorations.

There have been attempts in the prior art to prioritize data backup and restoration and reduce down time during restoration, such as that described in U.S. Pat. No. 6,880,051 to Timpanaro-Perrotta. In this prior art approach, data files are assigned priority values that determine the order in which they are backed up from a primary storage device to a backup storage device, and the order in which they are restored from the backup storage device back to the primary storage device. The assigned priority values attach to both the back up and restoration and are the same for both the back up and restoration. They may be fixed in fields in the metadata of files and are determined generally based on their relevance to system functionality, particular applications, or specific users. The backup and restoration approach is system- and hardware-dependent and Timpanaro-Perrotta identifies for example the IBM Tivoli Storage Management backup program as conducting the backup and restoration operations.

### SUMMARY OF THE DISCLOSURE

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a backup and restoration system includes a converter for converting files stored in a main storage device to flat files for storage in a backup storage device and a prioritizer for restoring the flat files from the backup storage device in accordance with a priority order that is independent of the order that the flat files were stored in the backup storage device.

In another embodiment, a backup and restoration method includes converting files stored in a main storage device to flat files, storing the flat files in a backup device, and restoring the flat files from the backup device based on a restoration priority order that is independent of an order in which they were stored in the backup device.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of a system 100 for performing dynamically-prioritized data restoration in accordance with certain embodiments.

FIG. 2 is a flow diagram showing the backup process 200 performed by backup and restoration system 102 of system 100 in accordance with certain embodiments.

FIG. 3 is a flow diagram showing the backup process 300 performed by backup and restoration system 102 of system 100 in accordance with certain embodiments.

FIG. 4 is a block diagram of a computer system 400 that can be employed to execute one or more embodiments of the present disclosure.

### DETAILED DESCRIPTION

Embodiments of the present disclosure will now be described in detail with reference to the accompanying figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to computer data preservation and, more particularly, to backup and restoration of computer data.

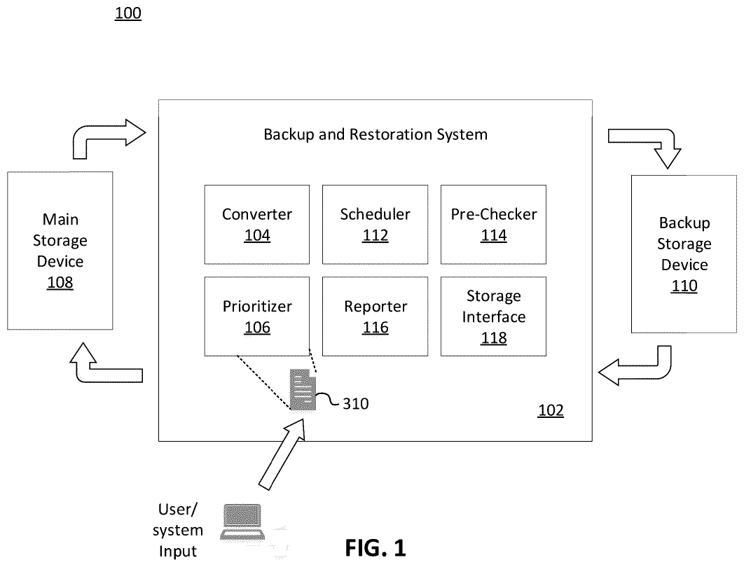

FIG. 1 is a block diagram of a system 100 for performing dynamically-prioritized data restoration in accordance with certain embodiments. System 100 incudes a backup and restoration system 102 having a converter 104 and a prioritizer 106. Backup and restoration system 102 is operable to back up data from a main storage device 108 to a backup storage device 110. When activated to perform a backup operation, for example in association with a scheduler 112, backup system 102 uses converter 104 to convert files from main storage device 108 to flat files and store them in backup storage device 110. When the files are ready to be restored from the backup storage device 110 to the main storage device 108, the order in which they are restored is selectable, based on user input to prioritizer 106 of the backup program. The files are retrieved from the backup storage device 110 in accordance with the selected order, reconverted to normal (non-flat) files and stored in main storage device 108. In certain embodiments, the order in which files are backed up from main storage device 108 to backup storage device 110 is also prioritizable.

Backup and restoration system 102 includes a pre-checker 114 configured to ascertain that the backup and restore conditions are met before these operations are commenced. For example, pre-checker 114 obtains confirmation from various systems such as the storage disk system, active directory (AD) systems, domain name systems (DNS) indicating that the system is online and reachable, the backup/restoration initiating account has the required authorization and privileges, sufficient disk space is available, and so on.

Backup and restoration system 102 also includes a reporter 116 that notifies stakeholders (such as data owners, data/operation monitoring operators, system administrators) of the outcomes of the various backup and restoration processes so that backup and restoration progress can be properly monitored and controlled as necessary. Interfacing with the main storage device 108 and backup storage device 110 for retrieval of data from one of these devices and writing it into the other device during the backup and restore operations is performed by storage interface 118.

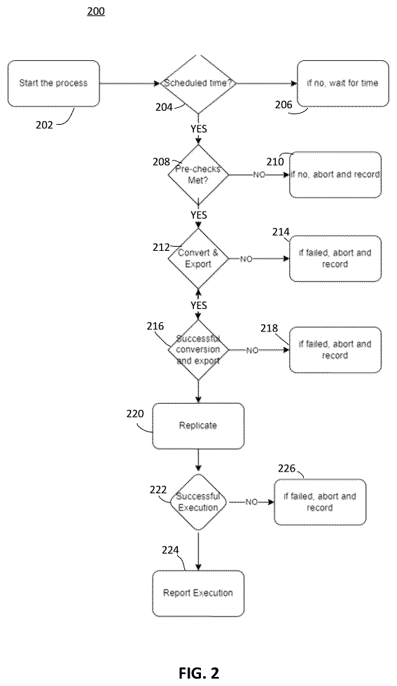

FIG. 2 is a flow diagram showing the backup process 200 performed by backup and restoration system 102 of system 100 in accordance with certain embodiments. The backup process begins at 202, initiated for example by scheduler 112 according to a predetermined schedule, or in accordance with a user command, or in response or anticipation of a system disruption or malfunction, such as a power outage, surge, or the like. Thus the determination is made at 204 of whether the backup time is appropriately scheduled or otherwise necessary or desired. If it is not, then the appropriate time is awaited at 206. If the backup time is determined to be appropriate, then the backup and restoration system 102 determines at 208 if backup pre-checks are met. This determination is made by pre-checker 114 which ascertains suitable backup conditions such as the system is online and reachable, the backup initiating account has the required authorization and privileges, sufficient backup or main storage space is available, and so on. Failure to meet the backup pre-check conditions aborts the process at 210, and a report of same is issued by reporter 116.

If the backup pre-check conditions are met on the other hand, then at 212 storage interface 118 obtains the data files from main storage device 108 and delivers them to converter 104 for conversion of the database schema data and its dependencies in main storage device 108 into flat files through an exportation process. Flat files, it will be appreciated, refers to data stored in plain text, schedule-free/structured-free format. They can be viewed and sorted with simple criteria. They are a bare means of storing table/databased/structured data but do not hold relations between the tables within them. In addition, flat files are simple in structure, taking up less space to store. In short, they can be viewed as database stores comprising single table structures rather than multiple tables/schemas/databases. Importantly, the flat file nature of the backed up files renders the backup and restoration process platform- and system-agnostic.

If the retrieval and/or conversion is unsuccessful, then at 214 the operations are aborted and a report issued to that effect by reporter 116. At 216, if the conversion is successful, then flow proceeds to the exportation step whereby storage interface 118 stores the flat files in backup storage device 110. Storage may be in accordance with a prioritization schedule whereby different files are stored based on a predetermined priority order. If the storage is unsuccessful, then at 218 the process is aborted and a report of same is issued.

The exportation process can be viewed as extracting and converting of data from their existing format (databases/structured/complex format) into the simpler, flat file, universal format. The exported data (Exportation process) may be stored/retained separately and act as a backup strategy and can be used to transfer data from one platform to another. The exportation process is an automated process to translate the data format from complex/platform/database dependence info standard/flat/text/portable format.

In certain embodiments, a replication step 220 is performed, replicating the flat files and storing multiple copies of them at different locations for redundancy and safety. In a cloud service environment, such multiple locations may be distributed over one or more networks and devices in the cloud.

At 222, it is determined if the above backup process was successfully executed, and a report of same is issued at 224 by reporter 116; otherwise, the process is aborted and failure is reported at 226 by reporter 116. In certain embodiments, reporter 116 reports success of some or all backup steps as well as failure.

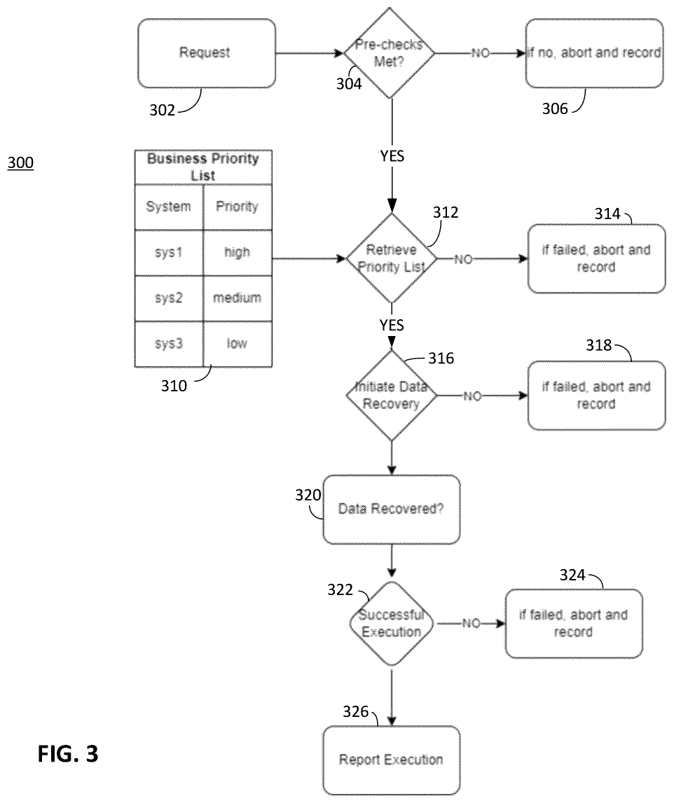

FIG. 3 is a flow diagram showing the restoration process 300 performed by backup and restoration system 102 of system 100 in accordance with certain embodiments. The restoration process begins at 302, initiated for example by scheduler 112 according to a predetermined schedule, or in accordance with a user command, or in response to other conditions such as restoration of power or termination of a threat or fault condition or resumption of normal operating conditions or the like. At 304, backup and restoration system 102 determines if restoration pre-check conditions are met. This determination is made by pre-checker 114 which ascertains suitable restoration conditions such as the system is online and reachable, the restoration initiating account has the required authorization and privileges, sufficient main storage space is available, and so on. Failure to meet the restoration pre-check conditions aborts the process at 306 and reports same by reporter 116.

If the restoration pre-check conditions are met on the other hand, then at 308 a restoration priority list 310 (FIG. 1) is retrieved, for example by storage interface 118. The restoration priority list 310 identifies an order in which the backed up flat files stored in backup storage device 110 are to be retrieved by storage interface 118. In the example shown in FIG. 3, the list associates system files sys1, sys2 and sys3 respectively with high, medium and low business priorities. Accordingly, sys1 is restored first, sys2 is restored second, and sys3 is restored last. More or less gradations of priority of course are contemplated, and numerical or other hierarchical designations for such gradations are also possible. Other priority lists that are not business based, but operations based, or are based on other criteria, are also contemplated. Moreover, multiple priority lists may exist, and they in turn are prioritized among each other in an inter-list priority, similar to the intra-list priority described above.

Returning to the restoration process 300 of FIG. 3, at 312 a determination is made if the list retrieval has succeeded. If not, then the process is aborted and reported at 314. The priority list(s) 310 is stored separately from the backed up data and its metadata, and may be accessed and written and modified by the system and/or users depending on changing conditions that can dictate other restoration priority orders than initially contemplated. The priority list can be maintained according to the application and business needs. The list can be maintained in any digital form. For instance, one organization can opt to store it in a cloud warehouse (e.g. public cloud provider), while other organizations are mandated to store it locally within the company premises/network. In certain embodiments, the priorities are set during the data recovery/data restoration. The data priority/data list can be updated/modified according to the business needs or circumstances, unlike in the prior art, in which the priorities of data are assigned during taking the backup and cannot be modified and updated to cater for the current organization conditions and requirements, which are not static and may change over time.

If retrieval of list 310 is successful, then at 316 data recovery is performed, with storage interface 118 obtaining the files in the order specified in list 310 from backup storage device 110 and storing said files in main storage device 108. Failure of this data recovery is reported and the process aborted at 318.

At 320, it is determined that all the data has been recovered, and at 322, it is confirmed that the restoration process has executed successfully. If not, the failure is reported by reported 116 and the process aborted at 324. Otherwise successful execution is reported at 326. In certain embodiments, reporter 116 reports success of some or all the restoration steps as well as failure.

It is important to note that priority list 310 is dynamic and can change based on changing priorities and conditions. More importantly, in certain embodiments, the list only defines the file restoration order, and is disassociated from the file backup process and order. In other words, at the backup stage, when a backup operation is performed, for example when initiated by scheduler 112 as described above according to a predetermined schedule, or in accordance with a user command, or in response or anticipation of a system disruption or malfunction, such as a power outage, surge, or the like, it may be expedient to implement the backup operation in bulk and dump the data from main storage device 108 en masse into backup storage device 110, or, in some circumstances, in accordance with a first priority order. However, when the restoration phase is commenced, an ordered and prioritized restoration based on the priority list 310, can be conducted by the backup and restoration system 102 because the order of file restoration is defined by separately-stored and accessed priority list 310 and is not built into the backup and restoration process a priori. Importantly, it can be selected and changed dynamically, based on changing system conditions, after backup has been implemented, as determined by the system or by users and administrators with proper credentials. The list defines a restoration order that is not necessarily the same as the first backup priority order even if such first backup priority order was used in lieu of a bulk back up. Thus the restoration process is not tied-in to the backup process but is independent thereof, providing a dynamically changeable and selectable order of file restoration. It also permits restoration granularity, whereby specific files can be selected for restoration.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, as used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

In view of the foregoing structural and functional features described above, example methods will be better appreciated with reference to FIGS. 2-3. While, for purposes of simplicity of explanation, the example methods of FIGS. 2-3 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods.

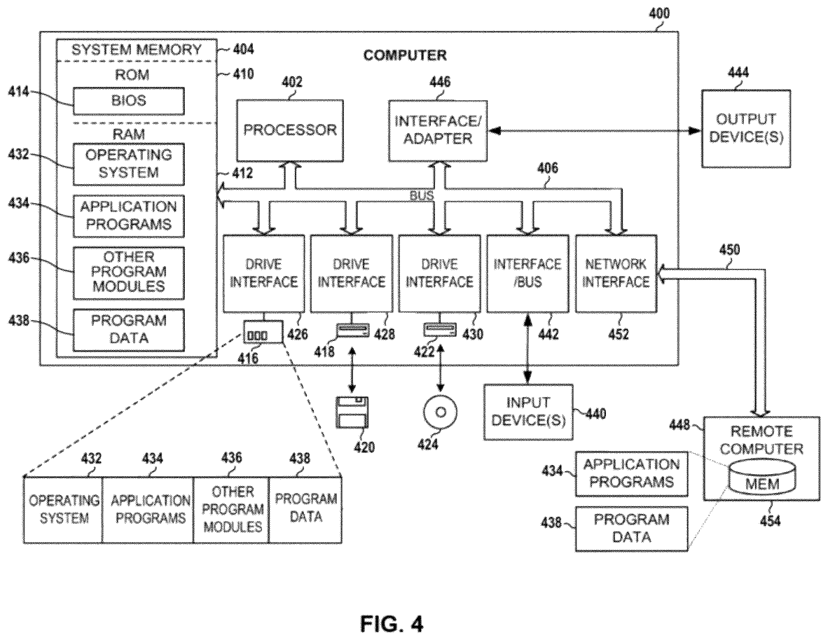

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 4. Furthermore, portions of the embodiments may be a computer program product on a computer-usable storage medium having computer readable program code on the medium. Any non-transitory, tangible storage media possessing structure may be utilized including, but not limited to, static and dynamic storage devices, hard disks, optical storage devices, and magnetic storage devices, but excludes any medium that is not eligible for patent protection under 35 U.S.C. § 101 (such as a propagating electrical or electromagnetic signal per se). As an example and not by way of limitation, a computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, where appropriate.

Certain embodiments have also been described herein with reference to block illustrations of methods, systems, and computer program products. It will be understood that blocks of the illustrations, and combinations of blocks in the illustrations, can be implemented by computer-executable instructions. These computer-executable instructions may be provided to one or more processor of a general purpose computer, special purpose computer, or other programmable data processing apparatus (or a combination of devices and circuits to produce a machine, such that the instructions, which execute via the processor, implement the functions specified in the block or blocks.

These computer-executable instructions may also be stored in computer-readable memory that can direct a computer or other programmable data processing apparatus to function in a particular manner, such that the instructions stored in the computer-readable memory result in an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks.

In this regard, HG, 4 illustrates one example of a computer system 400 that can be employed to execute one or more embodiments of the present disclosure. Computer system 400 can be implemented on one or more general purpose networked computer systems, embedded computer systems, routers, switches, server devices, client devices, various intermediate devices/nodes or standalone computer systems. Additionally, computer system 400 can be implemented on various mobile clients such as, for example, a personal digital assistant (PDA), laptop computer, pager, and the like, provided it includes sufficient processing capabilities.

Computer system 400 includes processing unit 402, system memory 404, and system bus 406 that couples various system components, including the system memory 404, to processing unit 402. Dual microprocessors and other multi-processor architectures also can be used as processing unit 402. System bus 406 may be any of several types of bus structure including a memory bus or memory controller, a peripheral bus, and a local bus using any of a variety of bus architectures. System memory 404 includes read only memory (ROM) 410 and random access memory (RAM) 412. A basic input/output system (BIOS) 414 can reside in ROM 410 containing the basic routines that help to transfer information among elements within computer system 400.

Computer system 400 can include a hard disk drive 416, magnetic disk drive 418, e.g., to read from or write to removable disk 420, and an optical disk drive 422, e.g., for reading CD-ROM disk 424 or to read from or write to other optical media. Hard disk drive 416, magnetic disk drive 418, and optical disk drive 422 are connected to system bus 406 by a hard disk drive interface 426, a magnetic disk drive interface 428, and an optical drive interface 430, respectively. The drives and associated computer-readable media provide nonvolatile storage of data, data structures, and computer-executable instructions for computer system 400. Although the description of computer-readable media above refers to a hard disk, a removable magnetic disk and a Cl), other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 410, including operating system 432, one or more application programs 434, other program modules 436, and program data 438. In some examples, the application programs 434 can include one or more of converter 104, prioritizer 106, scheduler 112, pre-checker 114, reporter 116, and storage interface 118, and the program data 438 can include any of data in main or backup storage 108 and 110, and restoration priority list 310. The application programs 434 and program data 438 can include functions and methods programmed to conduct the backup and restoration, such as shown and described herein.

A user may enter commands and information into computer system 400 through one or more input devices 440, such as a pointing device (e.g., a mouse, touch screen), keyboard, microphone, joystick, game pad, scanner, and the like. For instance, the user can employ input device 440 to edit or modify the restoration priority list 310 for instance. These and other input devices 440 are often connected to processing unit 402 through a corresponding port interface 442 that is coupled to the system bus, but may be connected by other interfaces, such as a parallel port, serial port, or universal serial bus (USB). One or more output devices 444 (e.g., display, a monitor, printer, projector, or other type of displaying device) is also connected to system bus 406 via interface 446, such as a video adapter.

Computer system 400 may operate in a networked environment using logical connections to one or more remote computers, such as remote computer 448. Remote computer 448 may be a workstation, computer system, router, peer device, or other common network node, and typically includes many or all the elements described relative to computer system 400. The logical connections, schematically indicated at 450, can include a local area network (LAN) and a wide area network (WAN). When used in a LAN networking environment, computer system 400 can be connected to the local network through a network interface or adapter 452. When used in a. WAN networking environment, computer system 400 can include a modem, or can be connected to a communications server on the LAN. The modem, which may be internal or external, can be connected to system bus 406 via an appropriate port interface. In a networked environment, application programs 434 or program data 438 depicted relative to computer system 300, or portions thereof, may be stored in a remote memory storage device 454.

1. A backup and restoration system, comprising:
a memory device for storing instructions;
a processor operable to execute said instructions to implement:
a converter for converting all files that are to be backed up and that are stored in a main storage device to flat files for storage in a backup storage device;
a storage interface for retrieving a stored restoration priority list identifying a user-selectable flat file restoration priority order that is independent of an order that the flat files were stored in the backup storage device; and
a prioritizer for restoring the flat files from the backup storage device in accordance with the user-selectable priority order of the restoration priority list.

2. (canceled)

3. The system of claim 21, wherein the restoration priority list enables granular file restoration whereby individually-selectable files can be restored.

4. The system of claim 1, wherein the processor is further operable to execute the instructions to implement a scheduler for initiating backup or restoration according to a predetermined schedule, or in accordance with a user command, or in response or anticipation of a system disruption or malfunction, a power outage, power surge, restoration of power or termination of a threat or fault condition or resumption of normal operating conditions.

5. The system of claim 1, wherein the processor is further operable to execute the instructions to implement a pre-checker configured to ascertain that backup and restore conditions are met before backup or restoration operations are commenced.

6. The system of claim 1, wherein the processor is further operable to execute the instructions to implement a reporter for reporting progress of backup or restoration operations.

7. The system of claim 1, wherein the storage interface is operable to retrieve and store for retrieving and storing files in the main storage device and the backup storage device.

8. A backup and restoration method comprising:
converting all files that are to be backed up and that are stored in a main storage device to flat files;
storing the flat files in a backup device; and
generating a list identifying a user-selected restoration priority order that is independent of an order in which the flat files were stored in the backup device;
restoring the flat files from the backup device based on the user-selected a-restoration priority order.

9. (canceled)

10. The method of claim 8, further comprising determining the restoration priority order after storing in the backup storage device.

11. The method of claim 8, further comprising individually selecting files for restoration.

12. The method of claim 8, further comprising initiating backup or restoration according to a predetermined schedule, or in accordance with a user command, or in response or anticipation of a system disruption or malfunction, a power outage, power surge, restoration of power or termination of a threat or fault condition or resumption of normal operating conditions.

13. The method of claim 8, further comprising ascertaining that backup and restore conditions are met before backup or restoration operations are commenced.

14. The method of claim 8, further comprising reporting failure of backup or restoration operations.

15. The method of claim 14, further comprising reporting success of backup or restoration operations.
